(19) United States
(12) Patent Application Publication
(10) Pub. No.: US 2004/0162138 A1
(43) Pub. Date: Aug. 19, 2004

(54) Electronic game with vibrating feature

(76) Inventor: Michael Hammond, Dallas, TX (US)

Correspondence Address: Bell, Boyd & Lloyd LLC, P.O. Box 1135, Chicago, IL, 60690-1135, US

(21) Appl. No.: 10/776,758

(22) Filed: Feb. 10, 2004

Related U.S. Application Data
(60) Provisional application No. 60/446,276, filed on Feb. 11, 2003.

(51) Int. Cl. G06F 17/00

(52) U.S. Cl. 463/30

(57) ABSTRACT

The present invention is an electronic game that includes a first portion with a circuit capable of channeling data, vibrating means and at least one interface slot. At least one preselected input device is adapted to be received in the slot and engage switches electrically connected to the circuit. A second portion is adapted to be connected to the first portion to form a game body, whereby the game body is adapted to vibrate and move via the vibrating means when triggered by the circuit based on the switches engaged by the preselected input device.

### CROSS REFERENCE TO RELATED APPPLICATIONS

The present invention claims the benefit of priority under 35 U.S.C. § 119(e) to U.S. Provisional Patent Application No. 60/446,276 of Michael Hammond, entitled “ELECTRONIC GAME WITH VIBRATING FEATURE,” filed on Feb. 11, 2003, the entire contents of which is incorporated by reference herein.

### FIELD OF THE INVENTION

The present invention relates to an electronic game simulating a battle that vibrates and rolls during operation or play. More specifically, preselected disks are received in slots of the game that communicate with a microprocessor. The microprocessor turns a motor off and on, which vibrates the game depending on the particular disks or disk selected and received in the slots. Additionally, these disks can be used to play the game as a single player or against another player by connecting the games of each player.

### BACKGROUND OF THE INVENTION

Motorized, self-propelling toys are known in the art. The driving unit of such toys is commonly positioned within the toy to cause the toy to move eccentrically. For example, weighted pendulums have been used to alter the movement of motorized spherical devices. Alternatively, motors have been placed off center from the axis of a spherical toy to offset the center of gravity of the driving mechanism, and thereby cause the spherical toy to move eccentrically. Additionally, weights have been used that are offset from the axis of a spherical toy to cause eccentric movement. Combinations of such driving means have also been used. Others hollow toys include a track positioned within the toy and driving mechanism that moves along the track and thereby propels the toy.

Additionally, games using fighting characters are well known in the art. Many of these characters have differing attributes, such as speed, strength, hit points and magic. Furthermore, these characters can become more powerful or experienced as they progress through specific experiences or battles.

### SUMMARY OF THE INVENTION

An object of the present invention is to provide an electronic game that interfaces with disks preselected by the player.

Another object of the present invention is to provide an electronic game that vibrates and rolls in response to preselected disks interfaced with the game.

Yet another object of the present invention is to provide an electronic game that includes first and second halves wherein a single player can play the game with the first and second halves connected or two players can play the game by connecting their respective first halves.

These objects are achieved by an electronic game, including a first portion with a microprocessor, vibrating means and at least one interface slot. At least one preselected input device is adapted to be received in the slot and engage switches electrically connected to the microprocessor. A second portion is adapted to be connected to the first portion to form a game body. Whereby the game body is adapted to vibrate and move via the vibrating means when triggered by the microprocessor based on the switches engaged by the preselected input device.

The objects of the present invention are further attained by a method of using an electronic gaming device, the gaming device including a housing, a circuit capable for channeling data and a vibration means. The method includes the steps of selecting an input device, and coupling the input device to the housing so that the input device communicates with the microprocessor, which in turn selectively activates the vibration means based on the communication between the input device and microprocessor.

The objects of the present invention are further attained by a method of using an electronic gaming device, the gaming device including a housing, a circuit and a vibration means. The method includes the steps of selecting an input device and coupling the input device to the housing so that the input device communicates with the circuit, which in turn selectively activates the vibration means based on the communication between the input device and circuit.

Other objects, advantages and salient features of the invention will become apparent from the following detailed description, which, taken in conjunction with annexed drawings, discloses a preferred embodiment of the present invention.

### BRIEF DESCRIPTION OF THE DRAWINGS

Referring to the drawings which form a part of this disclosure:

FIG. 1 is a top perspective view of the electronic game in accordance with the preferred embodiment of the invention demonstrating the operation of the game;

FIG. 2 is a top perspective view of the electronic game in accordance with the preferred embodiment of the invention showing the operation set up of the game;

FIG. 3 is a top plan view of the electronic game illustrated in FIG. 1, showing the gate/start button and the three disk interfaces;

FIG. 4 is a side view of the electronic game in accordance with the preferred embodiment of the invention showing two halves of the game connected and a disk interfaced with the top half;

FIG. 5 is a bottom view pf the electronic game illustrated in FIG. 1;

FIG. 6 is a top perspective view of a disk that interfaces with the electronic game illustrated as FIG. 2;

FIG. 7 is a bottom plan view of the second or bottom half of the electronic game illustrated in FIG. 1, showing the hollow cavity of the bottom half;

FIG. 8 is a bottom perspective view of the bottom half of the electronic game illustrated in FIG. 1, showing six disks being stored in the hollow cavity of the bottom half;

FIG. 9 is a side elevational view of the electronic game in accordance with the preferred embodiment of the invention, showing the game in two player mode with a disk interfacing with one half of the game;

is a bottom perspective view of the first or top half of the electronic game illustrated in FIG. 3, showing a plate on the bottom of the top half;

FIG. 10 is a top perspective view of the electronic game shown in FIG. 1, showing a disk being inserted in a corresponding slot of the electronic game;

FIG. 11 is a partial side view of the electronic game shown in FIG. 9, showing the top and bottom halves of the game being separated;

FIG. 12 is expanded view of the electronic game shown in FIG. 1, showing the top and bottom halves after separation; and

FIG. 13 is a diagrammatic view of the electronics of in accordance with the preferred embodiment of the invention.

### DETAILED DESCRIPTION OF THE PREFERRED EMBODIMENT

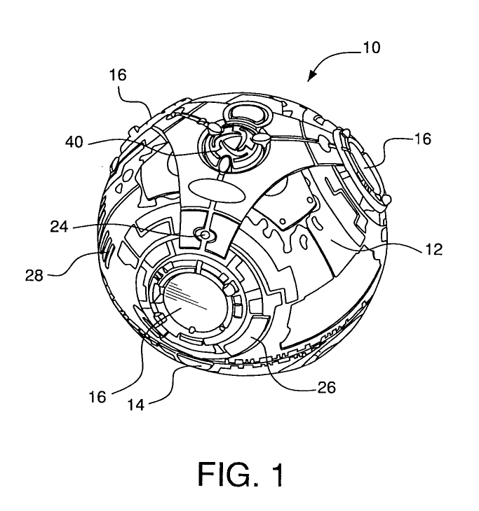

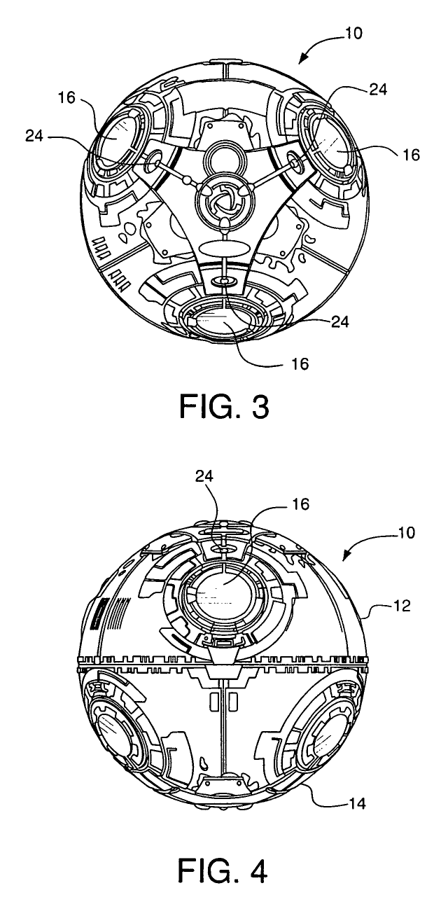

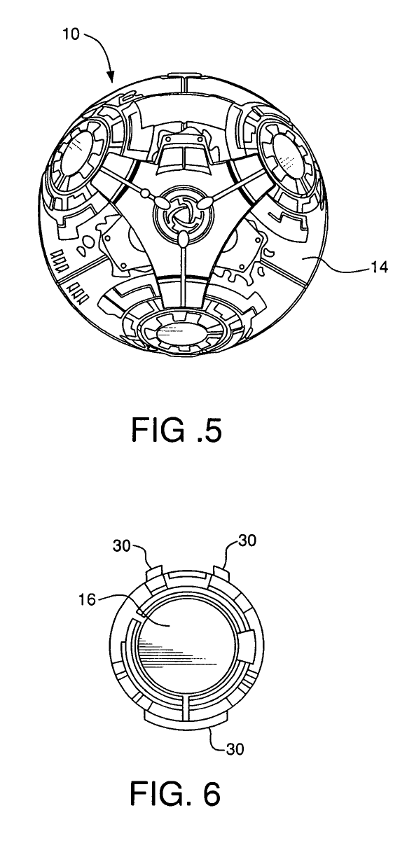

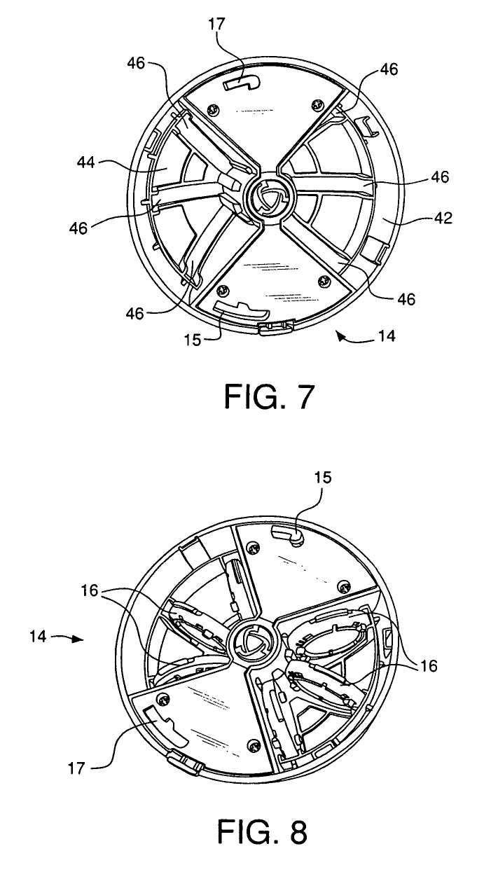

Referring to FIGS. 1-13, an electronic game in accordance with the present embodiment generally includes a spherically shaped game housing or orb 10 that includes first and second substantially semi-spherical halves 12 and 14 that connect to each other by a twist and lock arrangement. For example, as shown in FIGS. 7 and 8 each half of the game has a slot 15 and a protrusion 17. Each respective protrusion engages the respective slot on the other game half and when the game halves are twisted together, the two halves are locked together. However, any known locking arrangement, such as a snap fit or fasteners can be used to connect the two halves.

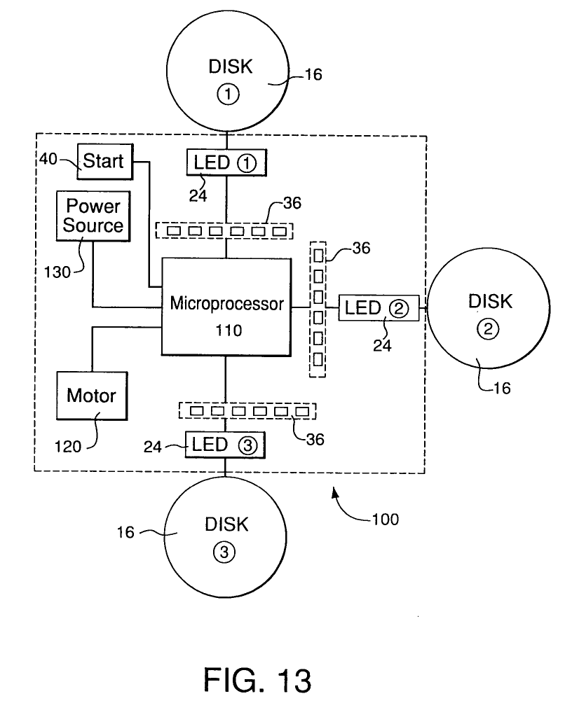

Orb 10 is preferably made of a molded elastomer; however, the orb 10 can be any material desirable. The first or top half 12 includes all of the electronics 100 (FIG. 13) for the game and the second or bottom half 14 is an empty shell.

As shown in FIG. 13, electronics 100 include among other things a microprocessor 110, motor 120, gear mechanisms and a power source 130, such as batteries. Disks 16, which interface with the orb 10 and electronics 100, provide the input and variables for the game. However, the specific electronics and mechanical features of this invention are merely preferred, each individual or the electronics and mechanical features as a whole can be replaced with any suitable system. For example, the microprocessor can be replaced with an suitable electrical circuitry or devices or a circuit capable of channeling data to the other mechanical and electrical features of this invention.

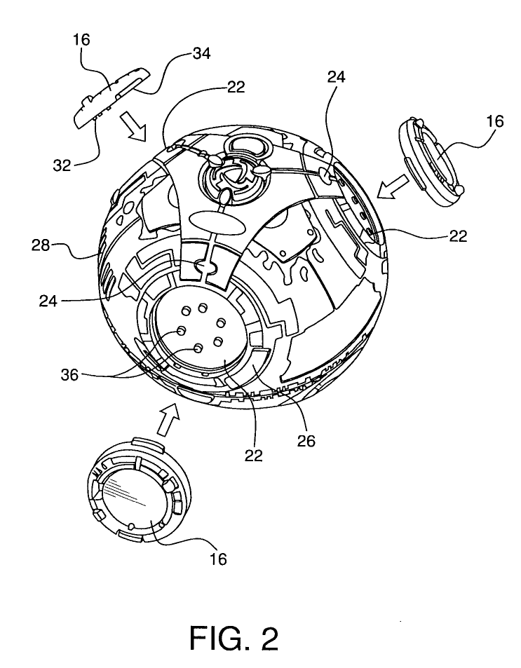

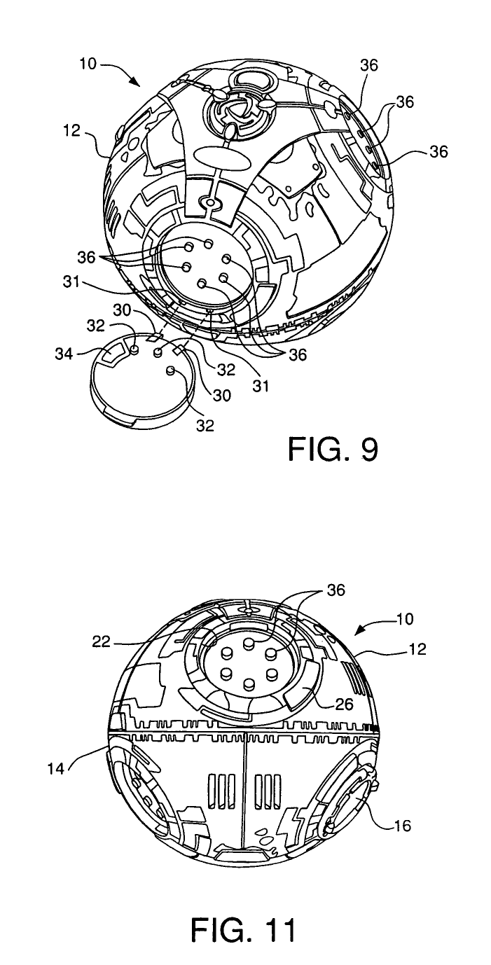

Disks 16 are preselected by the player, inserted into the orb (FIGS. 2 and 9) and are read by the microprocessor 110 for operation or play of the game, such as a battle or fighting scenario. The motor 120 generates vibration in accordance with the game play and the particular disks 16 selected by the player, causing the orb 10 to vibrate and roll.

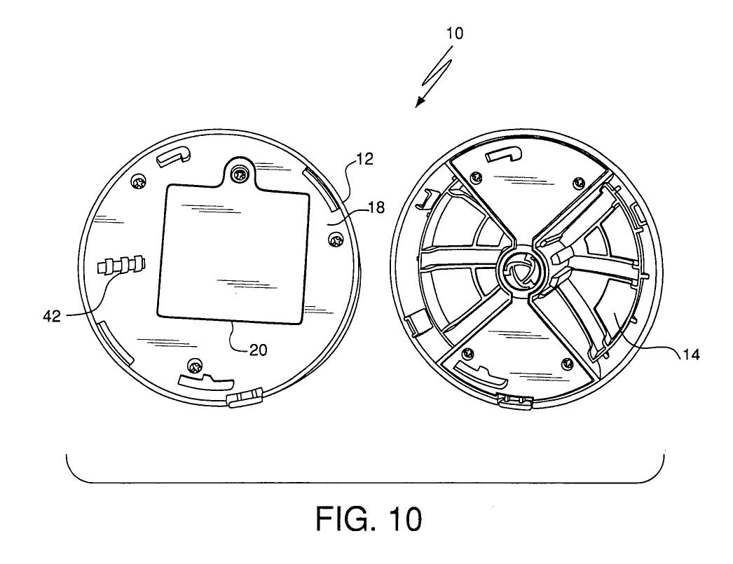

First or top half 12 encloses the electronics 100 of the game with a base plate 18 shielding the top half 12 (see FIG. 10). Base plate 18 provides access to the battery compartment 20.

As shown in FIGS. 1-5, three disk interface slots 22 are concentrically disposed in the top half 12 with a corresponding LED 24 and slot button 26 being disposed adjacent each slot 22, respectively. Preferably, the LEDs 24 are different colors, such as red, green and yellow; however, the LED colors can be any color desirable. A speaker 28 is also disposed in the top half 12 that is connected to the microprocessor 110 for audio output during game play. Second or bottom half 14 is an empty shell that can be used to store disks 16 (see FIGS. 7 and 8). Preferably, bottom half 14 has two compartments 43 and 44 that are configured to fit 3 disks 16 each. Each compartment has three slots 46 that each frictional hold a single disk 16 therein. However, it is not necessary to have this specific design and any design to hold any number of disks or no disks would be acceptable.

Three different disks 16 are selected from a group of preferably plastic disks 16, such as 63 disks, with each disk providing different input and variables for the game, e.g. each disk 16 represents a different fighting monster. The different variables are preferably class (type of character, such as tech, magic and power) level, and hit points; however, the variables can be any desired. The each class of monster has differing attributes, for example, the tech class as an attack advantage, power has a defense advantage and magic has a speed advantage. The level determines a range of hit points a monster has, and the hit points signify how much damage a monster can give or take.

Once three different disks 16 are selected, they are inserted into the disk interface slots 22 of the orb 10, as shown in FIGS. 2 and 9. More specifically, as shown in FIGS. 6 and 9, each disk 16 includes peripheral tabs 30 that are received in peripheral openings 31 of a respective disk interface slot 22 to secure the disk 16 within the slot. The slot button 26 is used to release the disk 16 from the interface slot 22.

Each of the three slots 22 preferably has a specific function in the game; for example one slot is preferably are categorized as leader, one as aggressor, and one as defender. These categorizes allow you to select which monster will attack first. Specifically, during game set up, the user can select to lead with anyone of these categorizes or with mayhem, which will randomly select which category to lead with.

Microprocessor 110 is programmed to recognize each disk 16 of the group of disks and operates the game according to the particular disks 16, i.e. three disks that have been selected and inserted into the disk interface slots 22.

As shown in FIGS. 2 and 9, disks 16 include outwardly extending concentric tabs 32 on their posterior surfaces 34 in different numbers and locations, respectively, for communicating with the microprocessor which monster a particular disk 16 represents. Each disk 16 includes a different number and combination of tabs 32. The outwardly extending tabs 32 of the disks 16 engage corresponding buttons or switches 36 of the disk interface slots 22 that are connected to microprocessor 110 thus communicating with microprocessor 110 which monster that particular disk represents. For example, an individual disk 16 can include 3 concentric tabs 32 that engage or press 3 of 6 concentric buttons 36 of a respective interface slot 22 (see FIG. 9).

Each disk represents a separate and distinct character that fights in a simulated battle. Preferably, each disk represents a specific monster or other alien creature; however, the actual character can be any type desired. The monsters are represented by a combination of tabs 32. When the disk 16 is inserted into the slot 22, a specific combination of tabs 32 communicates with the microprocessor 110 through switches 36.

Game Play

In the electronic game of the present invention, the player picks the monsters/disks 16 to battle with, and the battle strategy and this decides the outcome of the battle. Once the battle begins, the player has little control. It is a game of strategic set-up and wait-and-see.

The orb 10 is a plastic sphere to which the player attaches their 3 monster disks (see FIG. 2). Each monster disk is different, and each of the monsters' powers increase over time as battles are won. The player chooses the monsters/disks they want to use and inserts them into the 3 designated slots of the orb.

Once the top and bottom halves are locked together, the start/gate button 40 (FIG. 1) is depressed to begin the game. The orb begins to roll around via motorized vibration. Specifically, motor 120 triggered by microprocessor 110 spins a mass in different intervals causing it to roll and vibrate during battle. Lights (LEDs 24) flash and the monsters make sound heard through speaker 28. The game or battle continues until one side is defeated.

The orb 10 is where the monsters fight. The orb itself has no affect on the battle or the monsters. A battle occurs when the orb is loaded with three different monster disks 16. There is one monster per disk 16, with numerous, e.g. 63, total possible monsters. Each monster has the following attributes: class, hit points, attack, defense, and speed. The attributes for each monster are saved in the orbs' microprocessor 110. After a battle, if the team wins the microprocessor 110 records one win.

Furthermore by experiencing battles, the microprocessor increases the statistics for a monster on the winning team. For example, the winner's weakest monster (the one with the least amount of hit points) will now have the same amount of hit points as the loser's strongest monster. Hit points signify how much damage a monster can give or take.

Single Player

For a single player, the player plays against the game or more specifically, the microprocessor 110. Three disks 16 are selected by the player and inserted into each of the three disk interface slots 22 of the orb top half 12. The bottom half shell 14 is secured to the top half 12 by a twist and lock attachment. The start/gate button 40 is depressed, thereby waking the game from sleep mode. Microprocessor 110 recognizes which three disks (monsters) have been selected and inputted into the orb and the game commences based on those selections. The microprocessor 110 will trigger the motor and mass 120 and LEDs 24 to simulate a battle. This results in the orb 10 vibrating and rolling around and LEDs 24 illuminated during game play. Microprocessor 110 is programmed to turn the vibration on and off via motor 120 depending on which disks are selected and thus which battle scenario results. Similarly, microprocessor 110 is programmed to leave the LEDs 24 on or off or flashing depending on the battle scenario. Therefore, a unique sequence of vibration on and off, rolling, and illuminated LEDs is produced by microprocessor 110 depending on the selected three disks 16.

Note that although three disks 16 and three interfaces slot 22 are preferable, any number of disks 16 and slots 22 can be used including a single disk and slot. Additionally, although orb 10 is preferably spherically shaped, orb 10 can have any desired shape.

Two Players

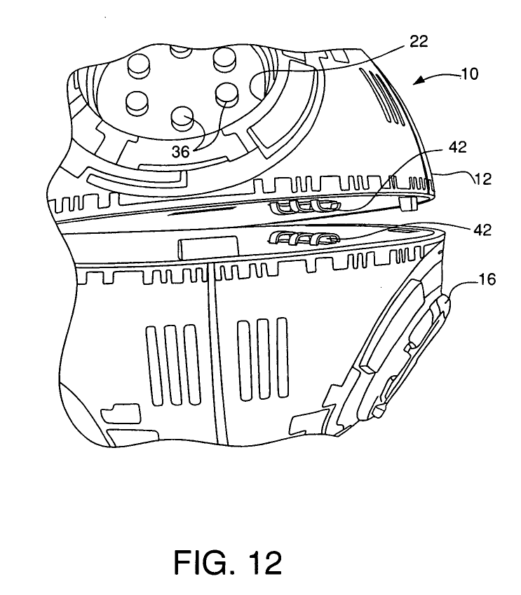

For two players, as shown in FIGS. 11 and 12, each player selects and inserts three disks 16 into their respective orbs 10 in the same manner as described above for a single player. The top halves 12 of each players' orb 10 are detached from their bottom halves 14 and attached to each other via a twist and lock arrangement to from a single orb. Contacts 42 of each players top half 12 are exposed at base plate 18 and engage one another upon attachment of the two players' top halves 12. This provides communication between the microprocessors of each half thus allowing game play or battle between the two halves of each player. The two microprocessors will determine a winner based on the characters attributes described above and a certain level of randomness.

Once the battle is completed, a winner is declared with the winning half of the game flashing its lights. As described above, the winner's weakest monster now becomes as strong as the losers strongest monster. Additionally, the leader of the of the winner's team is awarded items that can be used during battle. For example, some items are a speed potion that makes the monster harder to hit and a shield; however, any type of item desired can be awarded. Although a character's hit points can be increased in both single player mode and two player mode, items are preferably only awarded in two player mode. However, it is noted that any type of awards, including increased hit points and items can be awarded in any mode, if desired.

Furthermore, it is not necessary to limit the game to one or two players. The game can be designed to accommodate 3 or more players using the fighting guidelines described above.

While a particular embodiment has been chosen to illustrate the invention, it will be understood by those skilled in the art that various changes and modifications can be made therein without departing from the scope of the invention as defined in the appended claims.

What is claimed is:

1. An electronic game, comprising:
a game body including a circuit capable of channeling data, a vibrating means and at least one interface slot; and
at least one preselected input device adapted to be received in said slot and engage switches electrically connected to said circuit;
whereby said game body is adapted to vibrate and move via said vibrating means when triggered by said circuit based on the switches engaged by said preselected input device.

2. An electronic game according to claim 1, wherein
said game body is substantially spherical and is adapted to roll via said vibrating means.

3. An electronic game according to claim 1, wherein
said at least one interface slot includes at least three interface slots; and
said at least one preselected input device is adapted to be received in one of
said at least three interface slots.

4. An electronic game according to claim 3, wherein
said at least one preselected input device includes at least three preselected input devices; and
each of said at least three preselected input devices is adapted to be received in any one of said at least three interface slots.

5. An electronic game according to claim 4, wherein
said at least three interface slots are disposed on said first portion.

6. An electronic game according to claim 5, wherein
said at least three interface slots are concentrically disposed on said first portion.

7. An electronic game according to claim 1, wherein
said game body includes first and second portions; and
said first and second portions are each substantially hemispheres.

8. An electronic game according to claim 7, wherein
said second portion includes an area for storing said at least one input device.

9. An electronic game according to claim 7, wherein
said area is inside of said second portion.

10. An electronic game according to claim 7, wherein
said first portion is adapted to be connected to said second portion by a twist and lock arrangement.

11 An electronic game according to claim 1, wherein
said game body includes a speaker.

12. An electronic game according to claim 1, wherein
said at least one preselected input device includes tabs that are adapted to couple said input device to said game body within said interface slot.

13. An electronic game according to claim 1, wherein
said input device includes projections that are adapted to selectively engage said switches.

14. An electronic game according to claim 1, wherein
said switches include at least six switches, each of which is disposed within said slot; and
said input device includes between one to six projections adapted to selectively engage between one and six of said switches.

15. An electronic game according to claim 1, wherein
game body includes lights that are selectively controlled by said circuit.

16. An electronic game according to claim 1, wherein
said at least one input device is a disk.

17. An electronic game according to claim 1, wherein
said circuit includes a microprocessor.

18. A method of using an electronic gaming device, the gaming device including a housing, a circuit and a vibration means, the method comprising the steps of:
selecting an input device;
coupling the input device to the housing so that the input device communicates with the circuit, which in turn selectively activates the vibration means based on the communication between the input device and circuit.

19. A method according to claim 18, wherein
the coupling step includes coupling the input device to the housing by inserting the input device into an interface slot in the housing.

20. A method according to claim 19, wherein
the coupling step includes inserting an input device having at least one projection thereon into an interface slot having a plurality of switches that are in electrical communication with the circuit, the at least one projection engaging at least one of the plurality of projections.

21. A method according to claim 18, wherein
the selecting step includes selecting a substantially disk shaped input device.

22. A method according to claim 18, further including the step of
initiating the selective activation of the vibration means.

23. An electronic gaming device, comprising:
a first portion including a first circuit adapted to channel data, a first vibrating means, a first interface slot and first and second switches electrically connected to said first circuit;
a preselected first input device adapted to be received in said first slot and engage at least one of said first and second switches;
a second portion including a second circuit adapted to channel data, a second vibrating means, a second interface slot and third and fourth switches electrically connected to said second circuit, said second portion adapted to be connected to said first portion to form a game body; and
a second preselected input device adapted to be received in said second slot and engage at least one of said third and fourth switches;
whereby said game body is adapted to vibrate and move via said first and second vibrating means when triggered by said first and second circuit based on said first preselected input device engaging at least one of said first and second switches and said second preselected input device engaging at least one of said third and fourth switches.

24. An electronic gaming device according to claim 23, wherein
said game body is substantially spherical and is adapted to roll via said first and second vibrating means.

25. An electronic gaming device according to claim 23, wherein
said first portion includes third and fourth interface slots; and
said second portion includes fifth and sixth interface slots.

26. An electronic gaming device according to claim 25, wherein
said first, third and fourth interface slots are concentrically disposed on said first portion; and
said second, fifth and sixth interface slots are concentrically disposed on said second portion.

27. An electronic gaming device according to claim 23, wherein
said first and second portions are each substantially hemispheres.

28. An electronic gaming device according to claim 23, wherein
said first and second portions each include a speaker.

29. An electronic gaming device according to claim 23, wherein
said first portion is adapted to be connected to said second portion by a twist and lock arrangement.

30. An electronic gaming device according to claim 23, wherein
said first device includes at least one projection that is adapted to selectively engage at least one of said first and second switches; and
said second input includes at least one projection that is adapted to selectively engage at least one of said third and second switches

31. An electronic gaming device according to claim 23, wherein
each of said first and second portions include lights that are selectively controlled by said first and second circuits, respectively.

32. An electronic gaming device according to claim 23, wherein
each of said first and second input devices is a disk.

33. An electronic gaming device according to claim 23, wherein
said first and second circuits include first and second microprocessors, respectively.
